(19) United States
(12) Patent Application Publication
(10) Pub. No.: US 2026/0256634 A1
(43) Pub. Date: Sep. 3, 2026

(54) DRIVE SYSTEM COMPRISING A STEP-PLATE ELEMENT, AND OPERATING METHOD

(71) Applicants: BROSE FAHRZEUGTEILE SE & CO. KOMMANDITGESELLSCHAFT, BAMBERG, Bamberg (DE); BODE - DIE TÜR GMBH, Kassel (DE)

(72) Inventors: Markus ROSENTHAL, Bamberg (DE); Christian GITTER, Zeil am Main (DE); Thomas GOLDMANN, Bayreuth (DE); Björn FÜRST-NEUENDORF, Hallstadt (DE); Andreas PELLEGRINI, Edermünde (DE); Jana ENGE, Baunatal (DE); Lars LINNENKOHL, Staufenberg (DE); Maureen GEDECK, Kassel (DE)

(21) Appl. No.: 18/878,472

(22) PCT Filed: May 10, 2023
(86) PCT No.: PCT/EP2023/062421

§ 371 Date: Mar. 3, 2025

(30) Foreign Application Priority Data
Jun. 29, 2022 (DE) 10 2022 206 627.8

(51) Int. Cl. A61G 3/06; B60R 3/02; B60R 16/023; B60R 16/03; F16H 7/02; H02P 23/14

(52) U.S. Cl. CPC A61G 3/061; B60R 3/02; B60R 16/0231; B60R 16/03; H02P 23/14; F16H 7/023

(57) ABSTRACT

It is provided a drive system comprising an adjustable step-plate element for facilitating at least one of entry and boarding at an access opening of a vehicle, wherein the drive system comprises at least one drive unit with at least one drive motor for generating a driving force for the adjustment of the step-plate element and a drive mechanism for a transmission of the driving force to the step-plate element. The drive system comprises an electronic control unit which is configured to evaluate at least one measured value, which is characteristic of the operation of the drive unit, at least one of the drive motor and of a sensor of the drive system, which sensor is associated to the drive unit, for at least one of controlling and monitoring the at least one drive unit.

### CROSS REFERENCE TO RELATED APPLICATIONS

The present application is a U.S. National Phase of International Application No. PCT/EP2023/062421 entitled “DRIVE SYSTEM COMPRISING A STEP-PLATE ELEMENT; AND OPERATING METHOD,” and filed on May 10, 2023. International Application No. PCT/EP2023/062421 claims priority to German Patent Application No. 10 2022 206 627.8 filed on Jun. 29, 2022. The entire contents of each of the above-listed applications are hereby incorporated by reference for all purposes.

### BACKGROUND

The proposed solution in particular relates to a drive system comprising an adjustable step-plate element.

Step-plate elements for facilitating entry and/or boarding at an access opening of a vehicle are widely known in particular in local public transport. Corresponding step-plate elements typically are formed by manually adjustable ramps which can be folded out or pulled out by a driver of the vehicle, when necessary. The manual handling of the step-plate element is decisive to adjust the step-plate element into a desired end position and to also adjust the same back.

In particular for local passenger traffic there will be autonomously driving vehicles to an increased extent in the not-too-distant future. There will be used step-plate elements adjustable in a power-operated way, whose adjusting movement is controlled electronically. The functional reliability and functional safety must be ensured during the adjustment as far as possible without human intervention. In this respect, the proposed solution will provide an improvement.

### SUMMARY

The proposed drive system here comprises at least one drive unit with at least one drive motor for generating a driving force for the adjustment of the step-plate element and a drive mechanism for a transmission of the driving force to the step-plate element. Furthermore, there is provided an electronic control unit which, for controlling and/or monitoring the at least one drive unit, is configured to evaluate at least one measured value of the drive motor, which measured value is characteristic of the operation of the drive unit, and/or of a sensor of the drive system associated to the drive unit.

The proposed solution here in particular proceeds from the basic idea to detect electronic signals of components or sensors at or in the drive train and utilize the same for controlling and/or monitoring the at least one drive unit.

In principle, the electronic control unit can be configured to evaluate at least one curve of the at least one measured value for controlling and/or monitoring the at least one drive unit. For example, by interpretation of characteristic measured value curves and features in these measured value curves a particular operating state, a particular functional state and/or a particular adjustment position of the step-plate element can be inferred.

In one design variant, for example the evaluated measured value of the drive motor is a motor current or a drive torque. As a result, it then for example is not absolutely necessary to provide a separate sensor for the control of the drive unit. Rather, on the basis of the motor current for the drive motor conclusions can be drawn for the control of the drive unit, in particular for a current adjusting movement of the step-plate element, and/or data can be provided for monitoring the drive unit. Data for monitoring the drive unit here can be sent for a monitoring system wirelessly communicating with the drive system—for example in connection with a fleet management for a plurality of drive systems used on different vehicles.

Alternatively or additionally, a measured value of the sensor associated to the drive unit can be evaluated. For example, this can be a measured value of a Hall sensor or speed sensor or a capacitive sensor monitoring the surroundings of the step-plate element, of an optical sensor or ultrasonic sensor.

Independently of the source of the measured value evaluated on the part of the electronic control unit for example at least one curve of the at least one measured value can be evaluated for the occurrence of at least one signal curve characteristic for controlling and/or monitoring the at least one drive unit, which signal curve characteristic is representative of a particular operating state, a particular functional state or a particular adjustment position of the step-plate element. A signal curve characteristic occurring in the measured value curve can be representative of whether a particular operating state, a particular functional state or a particular adjustment position of the step-plate element is present. For example, a curve of a motor current of the drive motor and thus a motor current characteristic curve can be evaluated for this purpose.

For example, when on detection of a particular operating state or a particular functional state a signal curve characteristic is used in a corresponding measured value curve, an information on an adjustment position of the step-plate element can also be taken into account in addition. In particular for possible reactions to a detected signal curve characteristic triggered by the electronic control unit it can be decisive at what adjustment position of the step-plate element and hence at what time during an adjusting movement the signal curve characteristic has occurred.

Alternatively or additionally it can play a role where the drive system or the vehicle equipped with the drive system is located geographically. For example, when the drive system is provided for a vehicle of local passenger transport, an adjusting movement of the step-plate element to be carried out can depend on the place at which the step-plate element currently is to be extended, in particular at what stop the vehicle currently has stopped. In particular in this connection, the electronic control unit additionally can take account of information on a geographical position of the drive system for the detection of a particular operating state or a particular functional state. For this purpose, the electronic control unit for example receives a signal of at least one GPS sensor. This GPS sensor can form part of the drive system or, as part of the vehicle, can be coupled with the electronic control unit of the drive system, so that the electronic control unit can receive signals from the vehicle-mounted GPS sensor.

When the electronic control unit is configured, hence adapted and provided, to detect an information on an adjustment position of the step-plate element for a detection of a particular operating state or a particular functional state of the drive unit with reference to the signal curve characteristic, the adjustment position can be determined or have been determined in various ways. For example, the electronic control unit can receive an information on the adjustment position of the step-plate element from a sensor coupled with the drive system or from the sensor of the drive system associated to the drive unit or determine the same from the measured value curve of the evaluated measured value. For example from a motor current characteristic curve of the drive motor it can also be inferred at what point of an adjustment path possible between two end positions the step plate element is present. Via a predefined adjustment path of the step-plate element (with a trouble-free adjustment) a characteristic measured value curve is obtained, which can be stored in a reference curve. One or more current measured values for the motor current thus can provide information at what adjustment position the step-plate element currently is present by comparison with this reference curve. For example, when an atypical measured value then is detected for the motor current (atypical in the sense of a deviation from a reference value of the reference curve lying above a tolerance value), the electronic control unit furthermore can be configured to assess a corresponding atypical measured value as a signal curve characteristic and hence as an indication of a changed functional state or changed operating state of the drive unit, which has occurred at a particular adjustment position.

In one design variant, the electronic control unit can be configured to detect, with reference to the at least one signal curve characteristic,
an additional load on the step-plate element during the adjustment, or
a collision of the step-plate element during an adjustment of the step-plate element into an extension position, or
an extension of the step-plate element to or into a compliant surrounding material, in particular a snow pile, or
a sluggishness in the drive mechanism, or
a malfunction of the drive unit.

Depending on what kind of measured value curve is evaluated and how the signal curve characteristic turns out, the electronic control unit thus can detect various operating states and functional states.

The detection of an additional load on the step-plate element during the adjustment for example is understood to be a detection as to whether a tread surface of the step-plate element is additionally loaded while the step-plate element is adjusted into a retracted rest position or into an extension position. This for example also can include a possible snow load on the tread surface, when the step-plate element has remained in an extension position for a longer time. A corresponding additional load on a tread surface of the step-plate element then is reflected in a measured value curve, in particular for example the curve of a motor current, and hence can be utilized to cause possible counter-measures and/or for monitoring purposes.

The same also applies for the detection possibilities furthermore mentioned above. It can also be detectable for example with reference to a signal curve characteristic whether the step-plate element collides on extension. It can also be taken into account here at what geographical position the drive system and hence a vehicle integrating the drive system currently is located. Alternatively or additionally, it can also be inferred from a signal curve characteristic in a measured value curve whether a step-plate element currently is extended to or into a compliant surrounding material. For example, on extension of a step-plate element to a or into a snow pile a characteristic change of a measured value curve with respect to a reference curve is obtained, so that the electronic control unit of the drive system can react thereto correspondingly.

Possible cases of sluggishness in the drive mechanism of the drive system or malfunctions of the drive unit can easily be detected with respect to characteristic changes of measured value curves, in particular with respect to measured values for a motor current of the drive motor. In principle, a characteristic change of a temporal course of the measured value can also be taken into account in this connection. Hence, not only an individual measured value deviating from an expected reference value is decisive for the occurrence of a signal curve characteristic, but a temporal development of the respective measured value. In particular, a particular slope in the measured value curve and in particular one or more occurring jumps in the measured value curve can be decisive of whether or not a signal curve characteristic has occurred, which triggers a reaction on the part of the electronic control unit.

In a development, the electronic control unit can be configured to distinguish various signal curve characteristics from each other and in response thereto to generate different reaction signals. Consequently, the electronic control unit can distinguish various signal curve characteristics in a curve of one and the same measured value from each other and hence classify the same, so that depending on which signal curve characteristic is recognized as having occurred, a particular one of at least two different reaction signals can be generated. Reaction signal in particular is understood to be a control signal or an alarm signal. Thus, depending on the classification of a signal curve characteristic in particular another control signal and/or alarm signal can be generated on the part of the electronic control unit. For example, the drive motor of the drive unit can be actuated differently, depending on whether an additional load acting on the step-plate element during the adjustment, a collision of the step-plate element or the extension into a compliant surrounding material is detected with reference to the measured value curve. The electronic control unit likewise can be configured to distinguish a signal curve characteristic for a sluggishness in the drive mechanism or a malfunction from one of the aforementioned operating situations or changes in the operating state of the drive unit. For example, detected and evaluated changes in the measured value curve play a role for a detection of a possible sluggishness in the drive mechanism over several adjustment cycles. Typically, a wear-related sluggishness in the drive mechanism, which then is reflected in a detected motor current over the course of an adjusting movement, is not obtained abruptly, but is built up over several adjustment cycles.

A classification of various signal curve characteristics possibly also can include the fact that the classification is based on at least one additional sensor signal received at the electronic control unit. Such a sensor signal can originate e.g. from a sensor which does not belong to the drive system. For example an ambient sensor, which indicates a temperature above a particular temperature threshold value, for example above 20° C., or a sensor optically monitoring the surroundings of the step-plate element, which does not detect an obstacle in the surroundings of the extending step-plate element, can prevent that a particular signal curve characteristic is assessed as an indication of the fact that the step-plate element currently moves into a snow pile.

In principle, however, different signal curve characteristics for one and the same measured value can also be distinguished from each other, in particular when a motor current is evaluated. For example, it can be shown from analyses of different operating situations that a motor current is changed characteristically as compared to a reference curve, when a load is applied differently fast onto a tread surface of an adjusted step-plate element and/or the points at which the load is applied onto the tread surface differ from each other. In a design variant of a proposed drive system this consequently can be made use of in that the electronic control unit is configured to also recognize in dependence on the at least one signal curve characteristic what kind of load acts on the step-plate element and/or at what point the load acts on the step-plate element. Depending on what kind of load and/or what point for load application is classified on the part of the electronic control unit with reference to the signal curve characteristic, the drive motor of the drive unit can be actuated differently. In particular, it can also be provided in this connection that for recognizing what kind of load acts on the step-plate element and/or at what point the load acts on the step-plate element an information on the adjustment position of the step-plate element is taken into account additionally. For a particular reaction on the part of the electronic control unit it can very well play a role at what adjustment position of the step-plate element the occurrence of an additional load has been detected and hence at what time during an adjusting movement of the step-plate element the load is detected via the at least one signal curve characteristic.

For example, the electronic control unit in this connection is configured to recognize how fast and/or how long a load acts on the step-plate element, and based thereon distinguish at least two load cases from each other, which lead to different control signals generated by the control unit for controlling the drive motor in response to the detected additional load. For example, with reference to a measured value curve, in particular with reference to a curve of a detected motor current for the drive motor, it can be recognized whether a person abruptly steps onto a tread surface of the step-plate element while the step-plate element still is extended or retracted. With a further adjustment by the drive motor, a corresponding fast step of a person onto the still adjusted step-plate element can lead to a damage of the drive mechanism and/or an overload of the drive motor. In such a case, the electronic control unit then can be configured to reduce or entirely avoid the risk of a damage of the drive motor in that for example decoupling of the drive motor from the drive mechanism is triggered by the electronic control unit. When on the other hand a slow step onto the still adjusted step-plate element is detected with reference to the measured value curve, such a measure is not absolutely necessary in order to avoid damages at the drive unit. Here, it can be provided that the electronic control unit actuates the drive motor for a further adjustment of the step-plate element with a reduced adjustment speed. Thus, the electronic control unit in particular can be configured to recognize different cases of a load applied to a step-plate element with reference to the evaluated measured value curve and in particular an occurred signal curve characteristic.

In principle, the kind of transmission of the driving force from the drive motor to the step-plate element is independent of the proposed solution. Hence, differently configured drive mechanisms can be provided. In particular, for example the configuration of the drive mechanism with one or more spindle drives and/or joints is possible. Merely by way of example, one design variant provides that the drive mechanism comprises a belt drive for the transmission of the driving force to the step-plate element. The belt drive here for example can comprise a toothed belt.

In a possible development, the toothed belt meshes with a drive gear which can be driven by the drive motor to perform a rotation. Here it is conceivable in principle that the step-plate element to be adjusted is connected to the belt. However, there is also possible a configuration in which the belt is fixed to a guideway along which the step-plate element is shifted by rotating the drive gear. In the latter case, for example, the toothed belt is fixed at two longitudinal ends and the drive gear can be adjusted along the toothed belt via a rotary movement driven by the drive motor, in order to adjust the step-plate element.

For an adjustment of the drive gear along the toothed belt, a design variant for example provides that the drive gear is arranged between two guide rollers and the toothed belt extends along the two guide rollers and the drive gear in the shape of an omega. Thus, the toothed belt with one portion is guided on the two guide rollers and the interposed drive gear in the shape of an omega. A comparatively fast and harmonic adjusting movement of the step-plate element thereby is possible with a great robustness of the drive mechanism at the same time.

When a belt drive is used in the drive mechanism, this is also reflected in a course of a measured value detected for the drive motor, for example in the detected motor current or motor torque of the drive motor. In particular in the configuration mentioned above, in which an adjustment along the toothed belt fixed to the guideway is effected by the rotating drive gear, belt-related feedbacks to the driving force applied on the part of the drive motor and the related temporal development of a measured value allow to electronically draw conclusions as to the adjustment position of the step-plate element and/or the functional state at the belt drive. The electronic control unit hence can be configured to evaluate at least one signal curve characteristic caused by the belt drive in a curve of a measured value detected for the drive motor. Along the adjustment path of the step-plate element and/or at different operating and functional states, characteristic curves of the measured value occur on the basis of a displacing movement of the belt. Corresponding changes with respect to a reference curve can be recognized by the electronic control unit and can be evaluated with regard to the occurrence of a signal curve characteristic.

For example, the tensioning of the belt can have a measurable effect on the course of a motor current and a motor torque. In particular with a corresponding guidance of the toothed belt on a meshing drive gear, the cyclic engagement of a tooth into the toothed belt and a subsequent relaxation of the belt on bringing out of engagement can be readable with reference to a motor current signal. Depending on the point at which the drive gear meshes with the belt along its longitudinal ends, the action of the drive gear onto the belt leads to different displacing movements of the belt, in particular to vibrations. This is apparent for example in the curve of the motor current signal. A possible damage of the belt also can be recognized on a detected motor current signal.

For example, in one design variant use is made of the fact that the belt has a changing natural frequency along the adjustment path of the step-plate element and/or a natural frequency of the belt is changed at different operating and functional states of the drive unit. Correspondingly, a classification of different adjustment positions of the step-plate element can be effected for example via a frequency band of the natural frequencies.

Alternatively or additionally, a signal curve characteristic can originate from at least one displacing movement of the belt, which is specifically generated via at least one signal characteristic generator at the belt drive in at least one adjustment position of the step-plate element. For example, a corresponding signal characteristic generator is provided on a component of the belt drive in such a way that on at least one adjustment position of the step-plate element a displacing movement of the belt thereby occurs in a targeted way, which in turn results in a change of the driving force to be applied by the drive motor. Thus, the passing of the respective adjustment position for example has a direct effect on a detected motor current of the drive motor. Consequently, without any additional sensor system in the drive train and hence solely with reference to the motor current signal an adjustment position of the step-plate element thereby can be inferred. It can of course also be provided that several (at least two) signal characteristic generators are provided, via which a particular sequence of displacing movements of the belt can be generated. Alternatively or additionally, a specifically introduced displacing movement of the belt to be read e.g. from the motor current signal can be generated repeatedly. For example, a signal characteristic generator is formed by a radially protruding tab on a guide roller guiding the toothed belt.

In particular independently of the configuration of the drive mechanism, the electronic control unit in one design variant is configured to actuate or actively countersteer the drive motor before the reaching of a (final) extension position by the step-plate element via a reduced pulse width modulation signal (PWM signal). The basic idea of this design variant is to implement a speed-based damping on extension of the step-plate element, namely by a reduction of a PWM signal or by active countersteering. The electronic control unit of the drive system consequently is configured for realizing a speed-based damping on extension of the step-plate element. For example, it therefor is provided to actuate the drive motor via a PWM signal before the extension position is reached by the step-plate element, which only is a fraction of a PWM signal previously utilized for the adjustment. For example, before the extended position is reached, the drive motor merely can be actuated with less than 5%, e.g. 2% of the PWM signal, whereby the step-plate element then reaches its final extension position comparatively gently and hence not abruptly. This for example can take account of a tipping point in the drive mechanism, which is to be passed through on extension of the step-plate element.

A reduction in the PWM signal can be performed by the electronic control unit in response to the detection of a particular signal curve characteristic. For example, when it is recognized by means of the electronic control unit with reference to a motor current characteristic curve that the step-plate element is present in a defined adjustment range before reaching the specified extension position, the drive motor is actuated with a reduced PWM signal or actuated for countersteering so that the step-plate element reaches the extension position with a reduced adjustment speed.

In one design variant, the control unit is configured to actuate the drive motor for reaching an end position, e.g. a retracted rest position or extended extension position, in which the step-plate element has retracted into one end stop or several end stops, via a block sequence in which after an electronically controlled reduction of the driving force applied by the drive motor it is monitored at the drive mechanism whether a displacement of the step-plate element is effected in an opposite direction and, if such a displacement is detected, the drive motor again is actuated for generating a larger driving force. In this design variant, a specific block sequence consequently is provided for the retraction of the step-plate element into one or more end stops, which aims to avoid an excessive rise of the motor current on retraction by a targeted reduction of the driving force, but to nevertheless ensure that the step-plate element actually takes and maintains the particular end position. For example, on retraction in the direction of the respective end position an actuation voltage for the drive motor is decreased, in particular clocked down, for example by reduction of the duty cycle. When subsequently a displacing movement of the step-plate element in an opposite direction (i.e. against a direction of retraction into the end position) is detected, for example via one or more Hall sensors provided in the drive train, the motor current- and hence also an actuation voltage-is increased. In other words, for example the degree of modulation again is adapted in order to ensure a secure hold of the step-plate element in its end stops. With a corresponding block sequence it can thus be guaranteed that the step-plate element is disposed in its end stops and no longer moves without a permanently high block current having to be tolerated.

In one design variant of the proposed drive system, two drive units with one drive motor and one drive mechanism each are provided for adjusting the step-plate element. In this connection it can be provided that the drive units are provided for the joint adjustment of the step-plate element, hence for synchronously generating driving forces to extend and retract the step-plate element at the access opening of the vehicle. Here, for example, each drive unit is associated to a long side of the step-plate element so that on two long sides of the step-plate element facing away from each other a driving force can each be applied by one of the drive units for adjusting the step-plate element.

In connection with the proposed solution it can now in particular be provided in such a configuration of the drive system that for an adjustment of the step-plate element the drive motors of both drive units each generate a driving force and the electronic control unit is configured to evaluate the curve of a motor current or of a motor torque for each drive motor for the purpose of controlling the drive units. With reference to deviations in the curves of the two drive motors, changed operating states or functional states can be detected, for example. For example a signal curve characteristic, which has occurred merely in the measured value curve for one of the drive motors, suggests a particularity which only or at least more strongly influences one of the drive units.

For example, the electronic control unit in this connection can be configured to use the curves of the measured values for the various drive motors (in particular possibly occurring deviations in the curves) to detect at what point an additional load acts, which is applied onto the step-plate element. For example, a load eccentrically applied onto a tread surface of the step-plate element has a greater influence on a drive mechanism, and here in particular on one of the drive motors, as the load is applied closer to a long side of the step-plate element. In particular, a comparatively large load eccentrically acting on the step-plate element can lead to an undesired impairment of the adjusting movement of the step-plate element during an adjustment of the step-plate element. Against this background, the electronic control unit in a development can be configured to differently actuate the drive motors on detection of a load eccentrically acting on the step-plate element. Thus, the electronic control unit can actuate the drive motors for example (temporarily) for generating differently large driving forces and/or for generating different drive torques at the respective drive mechanism in order to counteract a load-related non-uniform adjustment of the step-plate element.

When two drive units are used in the drive system, the electronic control unit alternatively or additionally can be configured to operate the other drive unit in an emergency operating mode, when a malfunction of one of the drive units is detected. The drive units can each be operable in two different operating modes, wherein the drive units in a first, normal operating mode are provided and operated for the joint adjustment of the step-plate element supported by both drive units-hence for synchronously generating driving forces. In a second operating mode, an emergency operating mode, one of the drive units performs the adjustment of the step-plate element on its own and therefor is differently actuated correspondingly, in order to for example enable an at least one-time retraction of the step-plate element into a rest position or a one-time extension of the step-plate element into an extension position. With the step-plate element then still properly retracted by means of one of the drive units, the vehicle equipped with the drive system still can drive even further and visit a workshop.

The proposed solution furthermore also relates to a vehicle, in particular a vehicle for local public transport, which includes at least one design variant of a proposed drive system.

In addition, there is proposed a method for operating a drive system comprising an adjustable step-plate element for facilitating entry and/or boarding at an access opening of a vehicle, in which for controlling and/or monitoring at least one drive unit of the drive system at least one measured value of a drive motor of the drive unit, which is characteristic for the operation of the drive unit, and/or of a sensor of the drive system associated to the drive unit is evaluated.

Thus, a design variant of a proposed operating method in particular can be carried out by utilizing a design variant of a proposed drive system. The advantages and features of design variants of a proposed drive system as explained above and below thus also apply for design variants of a proposed operating method, and vice versa.

### BRIEF DESCRIPTION OF THE DRAWINGS

The attached Figures by way of example illustrate possible design variants of the proposed solution.

FIG. 1 schematically shows a step-plate element of a design variant of a proposed drive system in a partly extended state and loaded by a foot of a person.

FIGS. 2A-2B show various measured value curves for a drive motor for adjusting the step-plate element of FIG. 1 when loaded by the foot of the user.

FIG. 3A in a view corresponding with FIG. 1 shows the step-plate element during an adjusting movement.

FIG. 3B shows a motor current curve for an unimpeded adjusting movement of the step-plate element of FIG. 3A.

FIG. 4A in a view corresponding with FIG. 3A shows the step-plate element loaded by a person stepping onto the step-plate element.

FIG. 4B shows a motor current curve at the time of the loaded step-plate element.

FIG. 5A schematically shows the step-plate element when moving onto a snow pile.

FIG. 5B shows measured value curves for the step-plate element extending corresponding to FIG. 5A.

FIG. 6 shows a motor current curve for the step-plate element of FIGS. 1, 3A, 4A and 5A in the case of sluggishness occurring due to wear.

FIGS. 7A-7C show a design variant of a proposed drive system with a step-plate element during an adjustment into an extension position and by representing different areas of a load introduction by a person stepping onto the step-plate element.

FIG. 8 shows motor current curves for two drive motors utilized for the adjustment of the step-plate element of FIGS. 7A, 7B and 7C in the case of an eccentric tread.

FIG. 9 in a view corresponding with FIGS. 7A to 7C schematically shows the drive system by illustrating a malfunction of one of the drive motors.

FIG. 10 schematically shows flows of communication to a vehicle equipped with the drive system when stopping at different stopping points.

FIG. 11A in a view corresponding with FIG. 1 shows the step-plate element in different phases on extension.

FIG. 11B shows a motor current curve for a drive motor for adjusting the step-plate element of FIG. 11A by representing a speed-based damping on extension of the step-plate element.

FIG. 12 schematically shows different measured value curves for a retraction of the step-plate element into one or more end stops in connection with a block sequence.

FIG. 13 schematically shows a drive mechanism for the adjustment of the step-plate element by means of a toothed belt whose natural frequencies are evaluated during an adjustment of the step-plate element.

FIG. 14 in a view corresponding with FIG. 13 shows a development of the drive mechanism of FIG. 13 with a plurality of signal characteristic generators on a guide roller for guiding the toothed belt.

FIG. 15 shows a side view of a design variant of a proposed vehicle for the autonomous passenger transport.

FIG. 16 in an enlarged individual representation shows a design variant of a proposed drive system which is used in the vehicle of FIG. 15.

FIG. 17 on an enlarged scale shows a drive motor and parts of a drive mechanism of two drive units of the drive system of FIG. 16.

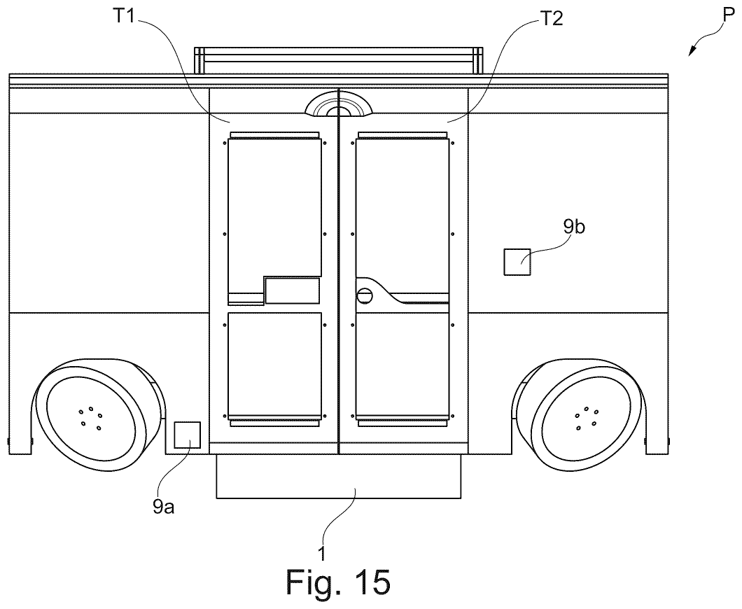

FIG. 15 shows an autonomously driving vehicle P which is also referred to as a so-called “People Mover” and in which a design variant of the proposed solution is implemented. The vehicle P offers room for example for up to 4, 6, 8 or 12 persons. The proposed solution can, however, of course also be employed in a non-autonomously driving vehicle of local public transport or in a vehicle with a smaller or larger interior space.

FIG. 15 shows the vehicle P in a state in which the vehicle P just has come to stop at a stopping point of a route and hence at a stop. Vehicle doors T1 and T2 of the vehicle P still are closed.

To enable persons to exit from the vehicle P or to enter into the vehicle P, the vehicle doors T1 and T2 can be swiveled or pushed open in order to clear an access opening at the vehicle P. In addition, at a lower edge of the access opening and hence at an entry edge a step-plate element 1 is extended as an exit or entry aid. Via this step-plate element 1 a tread surface is provided, which is meant to enable facilitated access to the vehicle P and facilitated exit from the vehicle P. The tread surface of the step-plate element 1 is located at a slightly lower level and/or at an angle to a floor in the interior space of the vehicle P, when the step-plate element 1 is properly extended.

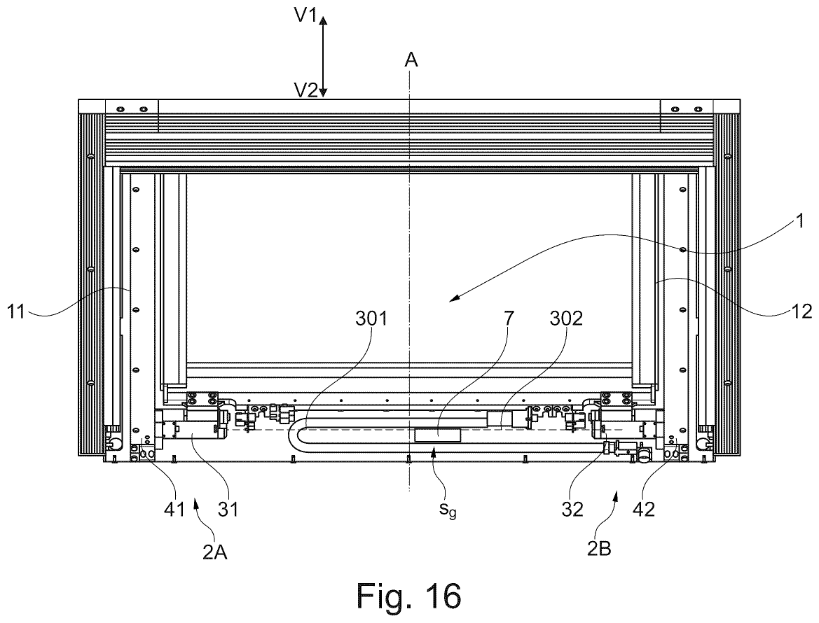

FIG. 16 illustrates a drive system including the step-plate element 1, which is integrated in the vehicle P. The step-plate element 1 here is longitudinally adjustable along an adjustment axis A along two mutually opposite adjustment directions V1 and V2 via two drive units 2A, 2B. The step-plate element 1 moreover can also be pivotable about a joint axis extending transversely to the adjustment axis A in order to provide a ramp in an extension position.

Each drive unit 2A, 2B is associated to one of two long sides 11, 12 of the step-plate element 1, so that from there a driving force generated by a drive motor 31 or 32 of the respective drive unit 2A or 2B is transmitted to the step-plate element 1. For the adjustment of the step-plate element 1 along the adjustment axis A, the drive motors 31 and 32 are actuated via an electronic control unit 7 of the drive system for a synchronous adjustment. For controlling and monitoring the drive units 2A and 2B this electronic control unit 7 is connected to the drive units 2A, 2B and in particular the drive motors 31 and 32 via two signal lines 301, 302.

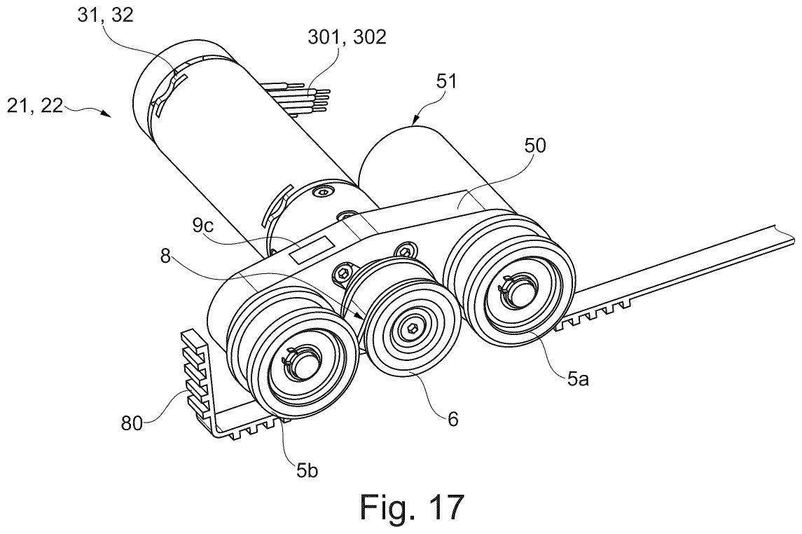

To transmit a driving force generated by a drive motor 31 or 32 to the step-plate element 1, each drive unit 2A or 2B includes a drive mechanism. This drive mechanism in particular comprises a guide profile 41 or 42 at which a belt drive is provided. FIG. 17 illustrates a design variant of this belt drive as part of the drive mechanism of the respective drive unit 2A or 2B. The belt drive in the present case comprises a toothed belt 8 which is fixed to the respective guide profile 41, 42. A portion of the toothed belt 8 is guided in the shape of an omega along two guide rollers 5a and 5b and an interposed drive gear 6. The drive gear 6 and the two guide rollers 5a and 5b are rotatably mounted on a connecting flange 50 of the drive unit 2A or 2B. The drive gear 6 furthermore is formed with an external toothing, which can mesh with teeth 80 of the toothed belt 8, and is coupled with the respective drive motor 31 or 32 so that on actuation of the drive motor 31 or 32 the drive gear 6 is put into rotation.

The drive motor 31, 32 with the connecting flange 50 supporting the guide rollers 5a, 5b and the drive gear 6 forms a guide unit 21 or 22 of the respective drive unit 2A or 2B, which is shiftable along the respectively associated guide profile 41 or 42. When the drive gear 6—which here is configured as a toothed belt gear meshing with the toothed belt 81—is driven to rotate, the entire guide unit 21 or 22 is displaced along the guide profile 41 or 42 in that the drive gear 6 engages into teeth 80 of the toothed belt 8. Each guide unit 21, 22 is connected to a long side 11 or 12 of the step-plate element 1 via a step-plate receptacle 51, so that with the adjustment of the guide units 21 or 22 along the respective toothed belt 8 or the guide profiles 41 or 42 the step-plate element 1 is retracted or extended along the adjustment axis A.

For controlling and monitoring the drive units 2A and 2B, the drive system can include a plurality of drive-side sensors, be coupled with vehicle-mounted sensors and/or evaluate one or more measured values of the drive motors 31, 32 characteristic for the operation of the drive unit. By way of example, FIGS. 15, 16 and 17 show a capacitive sensor, an optical sensor, a radar sensor or an ultrasonic sensor 9a for monitoring an environment of the step-plate element 1, a GPS sensor 9b and a position sensor, e.g. a Hall sensor, or speed sensor 9c. Signals of these sensors 9a, 9b, 9c alone or in combination with a motor current signal or torque signal for each drive motor 31, 32 can be provided for controlling and/or monitoring the drive units 2A, 2B by the electronic control unit 7. In possible design variants the utilization of merely one motor current signal or drive torque signal for controlling and/or monitoring the drive units 2A, 2B also is conceivable so that vehicle-mounted sensors or drive-train-side sensors therefor can be omitted.

Moreover, the provision of two drive units 2A, 2B for the adjustment of the step-plate element 1 within the illustrated drive system also merely is by way of example. For the power-operated adjustment of the step-plate element 1 also only exactly one drive motor can be provided. Correspondingly, for some of the design variants explained below a drive system with two drive motors 31, 32 is not absolutely necessary.

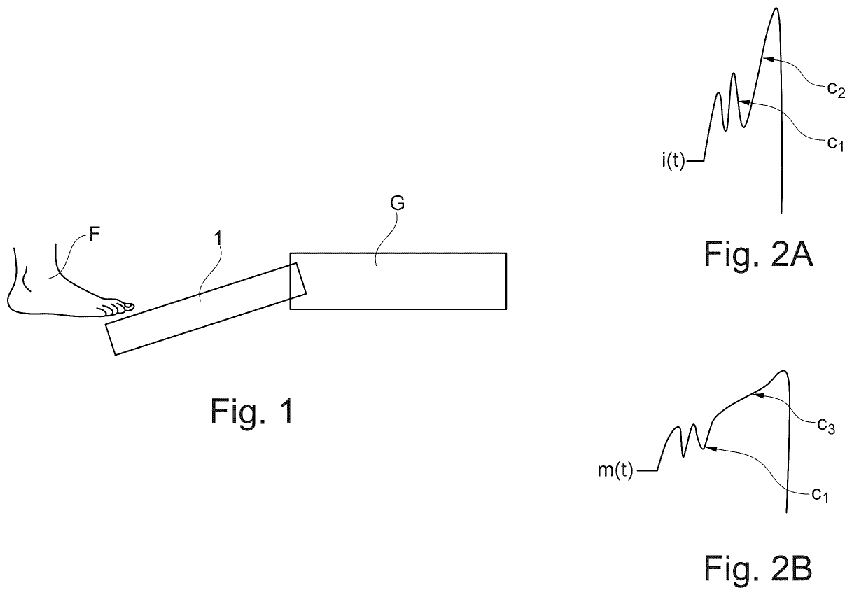

FIG. 1 by way of example illustrates an electronically controlled adjusting movement of the step-plate element 1 out of a housing G and relative to a base structure formed therewith, which is formed below a floor in the interior space of the vehicle P. The step-plate element 1 is schematically shown in FIG. 1 during an adjusting movement, during which a person steps onto a tread surface of the step-plate element 1 with his/her foot F. The electronic control device 7 now is configured to detect and distinguish particular operating situations during the adjustment of the step-plate element 1 with reference to signals on the part of the drive train, such as for example a motor current characteristic curve and/or other sensor data (e.g. for the position, speed and/or direction of rotation of a motor shaft), so that in dependence on a signal curve characteristic in a curve of a respectively detected measurement signal possibly with the additional use of further sensor signals-the operation of the drive system at the vehicle P can better be controlled automatically and/or can be monitored. In this connection it can be provided for example to interpret characteristic curves and features and hence signal curve characteristics in a motor current characteristic curve of a drive motor 31 or 32 (also in each case, if two drive units 2A, 2B are provided) by comparison with learned reference values and hence reference curves, so that the electronic control device 7 automatically can take measures in response to a detected operating situation.

FIGS. 2A and 2B in this connection illustrate different signal curve characteristics c₁, c₂, c₃ in measured value curves for a drive motor 31 or 32, via which different load cases with an adjusted step-plate element 1 can be distinguished and hence can be classified.

FIG. 2A for example illustrates the curve of a motor current i(t). This curve of the motor current i(t) for example in a time interval shows a first signal curve characteristic c₁ which is characteristic for the rising motor current when starting, when the step-plate element 1 must be retracted into a guide of the respective guide profile 41, 42, in order to be extended further. In the following, the curve of the motor current i(t) in FIG. 2A shows a further signal curve characteristic c₂, which is characterized by a steep rise of the motor current. At the relevant time, a user has stepped hard or fast onto the tread surface of the step-plate element 1 with the foot F. Hence, there is a steep current rise in the motor current for the respective drive motor 31 or 32 and a measurable rise in a torque to be applied by the respective drive motor 31, 32. To avoid an overload of the respective drive motor 31, 32 in such a situation, the electronic control unit 7 can be configured to trigger decoupling of the drive motor 31 or 32 on detection of such a signal curve characteristic c₂ or to even stop a further adjustment of the step-plate element 1.

With a slower step of a person onto the tread surface and/or a lower load, the motor current and the drive torque m(t) rises distinctly less steeply. This is illustrated by way of example in FIG. 2B. There is shown a curve of the drive torque m(t) for a drive motor 31 or 32. At one time, this drive torque m(t) has a signal curve characteristic c₃ which rises unusually strongly—as compared to an undisturbed adjusting movement and a resulting reference. The temporal course of this rise however differs distinctly and hence classifiably from the rise with a hard or fast step corresponding to FIG. 2A. In response to the occurrence of the signal curve characteristic c₃ corresponding to FIG. 2B, the electronic control unit 7 thus can take another measure, for example merely an adjustment of the step-plate element 1 with a lower adjustment speed (in particular for a defined reaction period and/or over a defined adjustment path range.

The electronic control unit 7 thus enables an expedient reaction to different load cases during the adjustment of the step-plate element 1. In the case of a high load, an adjusting movement can be stopped for example automatically in order to protect the respective drive mechanism and the drive motors 31, 32 from an overload. In addition, an independent renewed execution of the adjusting movement can easily be controlled electronically. The adjustment of the step-plate element 1 consequently can be automated in an intelligent way, as this is advantageous especially in an autonomously driving vehicle P.

Via a corresponding evaluation of drive-train-side measured values, such as for example the motor current and/or the drive torque, possible collisions (in particular along the adjustment axis A) can also reliably be detected electronically, possibly also without using any further sensor system. Analogously to the detection of a high load, an adjusting movement can also be stopped automatically in the case of a collision and can possibly be reversed in order to protect persons in the surroundings of the vehicle P from an injury and to prevent clamping cases.

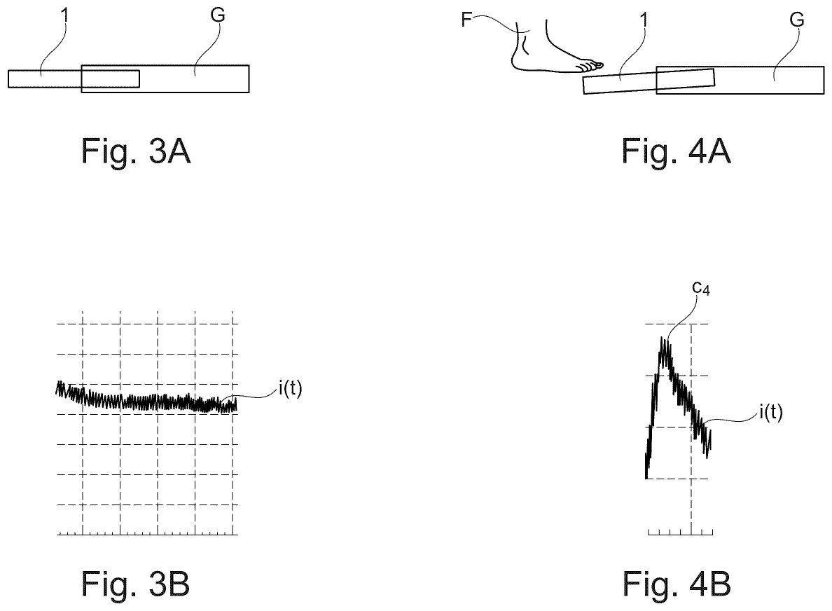

This procedure is also illustrated with reference to FIGS. 3A-3B and 4A-4B. FIG. 3A by way of example shows an undisturbed adjusting movement of the step-plate element 1. FIG. 3B by way of example illustrates a measured course of a motor current signal i(t) for this undisturbed power-operated adjusting movement. When corresponding to the representation of FIG. 4A an additional load now is applied onto the step-plate element 1, for example by setting a foot F of a person onto a tread surface of the step-plate element 1, a characteristic rise and subsequent drop in the curve of the motor current i(t) will appear, which is emphasized in FIG. 4B as the signal curve characteristic c₄.

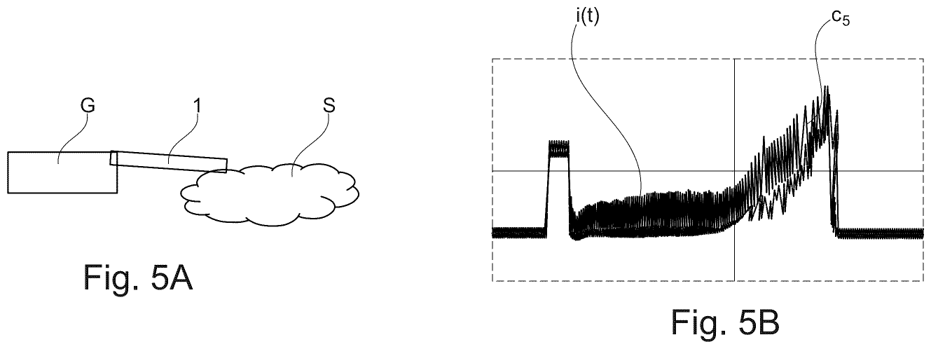

FIG. 5A illustrates a retraction of the step-plate element 1 into a snow pile S present in the surroundings of the vehicle P and a retraction of the step-plate element 1 into a rest position, in which at least at the beginning a portion of the step-plate element 1 still must be pulled out of the snow pile S.

Such an operating situation can also be detected electronically with reference to a motor current signal i(t) corresponding to FIG. 5B. Here as well, a signal curve characteristic c₅ appears in the motor current signal, which is evaluated on the part of the electronic control unit 7 and can be classified as an indication of the snow pile S. Thus, a snow action on extension or retraction of the step-plate element 1 can be detected electronically and in particular be distinguished from other load cases.

In particular, it can also be decisive for the classification as a snow load case how far the step-plate element 1 has been extended. For example, a snow pile S as a compliant surrounding material initially can effect a characteristic rising resistance against a further adjustment of the step-plate element 1 into a completely extended extension position and even prevent the complete extension of the step-plate element 1. The rise in the motor current signal corresponding to FIG. 5B thus for example is effected merely up to an adjustment position of the step-plate element 1 which is not extended completely.

In one design variant, at least one further sensor signal s_{g} of a drive-system-side sensor or a vehicle-mounted sensor can also be processed at the electronic control unit 7. For example, this can be a temperature sensor by means of which an information on a temperature in the surroundings of the vehicle P can be transmitted to the electronic control unit 7. For example, a corresponding signal curve characteristic c₅ corresponding to FIG. 5B can be learned by the electronic control unit 7 and be assessed as an indication of a snow load on the step-plate element 1, when at the same time an outside temperature does not lie above a particular threshold value. When the outside temperature lies above this threshold value, of e.g. 10° C., this rather speaks for the fact that no snow at all can be present in the surroundings of the vehicle P and the signal curve characteristic cs can be traced back to another cause.

An additional sensor signal s_{g} consequently can be utilized in principle for plausibilizing a classification made or taken into account with reference to a drive-train-side measured value curve, for example for a possible detection of an alleged snow load, which detection is made with reference to the signal curve characteristic c₅. In particular, the electronic control unit 7 in this connection can be configured to distinguish a snow load from a clamping case with reference to a signal curve characteristic and correspondingly perform a different actuation of the drive motors 31 and 32 in dependence on the respective detected load case, which in addition reduces the risk of wrong adjustments and hence increases the reliability of the drive system.

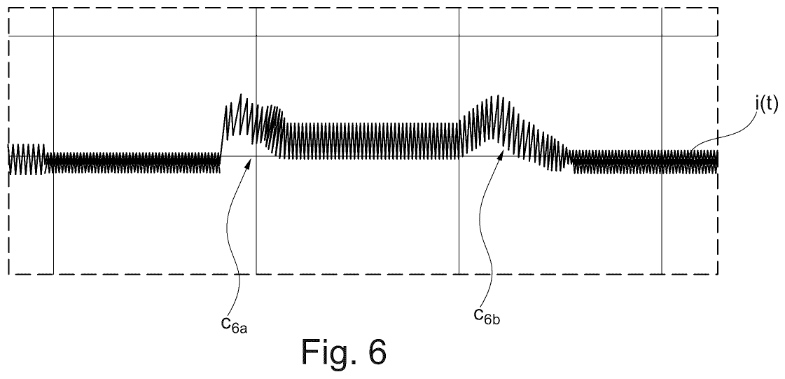

FIG. 6 shows a further curve of a detected motor current signal i(t) for one or more of the drive motors 31, 32. In this FIG., two temporally successive signal curve characteristics c₆ₐ and c_{6b} are highlighted. These characteristic changes of the motor current signal i(t) with respect to a reference curve differ distinctly from the signal curve characteristics c₁ to c₅ of the FIGS. explained above. These signal curve characteristics c₁ to c₅ in the present case indicate a creeping or abrupt change in the motor current signal curve, which for example indicates cases of sluggishness in the drive mechanism and in particular cases of wear-related sluggishness. Consequently, the signal curve characteristics c₆ₐ, c_{6b} for the electronic control unit 7 reveal that one or more cases of sluggishness, possibly even a damage, are present in the drive mechanism. Here, it can also be taken into account in particular that corresponding signal curve characteristics c₆ₐ, c_{6b} have occurred at a number of adjustments of the step-plate element 1 exceeding a minimum number.

Here, the electronic control unit 7 of the drive system consequently can be configured to detect cases of sluggishness and in particular damages on a drive mechanism, which in the present case for example comprises the belt drive with the toothed belt 8, with reference to changes with respect to a stored reference curve for the motor current signal i(t), which occur with reference to the curve of the motor current signal i(t), and in response thereto generate a control signal and/or alarm signal. Via a control signal, the respective drive motor 31 or 32 for example is driven for a changed adjustment, for example for an adjustment with a slower adjustment speed. Alternatively or additionally, a generated alarm signal can be used to indicate the sluggishness or the detected damage so that a repair of the drive mechanism can be effected as quickly as possible.

The matching of detected measured values for the motor current signal i(t) with a reference curve in particular can be effected in the variant of FIG. 6 (but also in all other design variants explained above and below) with an exact measured value or cyclically, in particular in order to detect recurring deviations from the respective stored reference curve at different adjusting movements.

Data on the detected signal curve characteristics c₆ₐ, c_{6b} (and also on other signal curve characteristics of the design variants explained above and below) furthermore can be sent to a superordinate monitoring system, in particular wirelessly. For example, such a monitoring system can monitor several vehicles P and in particular their drive systems.

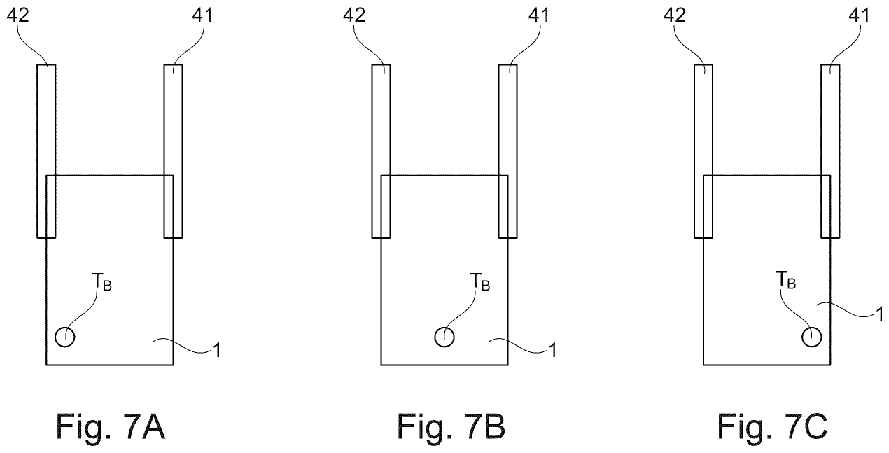

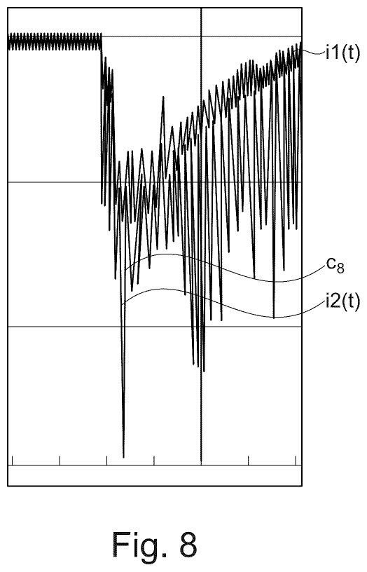

While in particular the different operating and functional states of the drive system as explained above also are easily detectable with reference to a curve of a motor current signal i(t) or drive torque curve m(t) by using an individual drive motor 31 or 32 for the adjustment of the step-plate element 1, FIGS. 7A to 7C and 8 illustrate a possibility for controlling and monitoring two drives 2A, 2B synchronously utilized for the adjustment of the step-plate element 1.

FIGS. 7A, 7B and 7C each schematically and in a top view show the step-plate element 1 during an adjusting movement along the adjustment axis A in the adjustment direction V1 or V2 relative to the guide profiles 41 and 42. FIGS. 7A, 7B and 7C only differ from each other in the representation of a tread area TB, on which a load acts on the step-plate element 1, here for example by a person stepping onto the step-plate element 1. In FIG. 7B a central step in a tread area TB is provided, while in FIGS. 7A and 7B a step is each made in an eccentric tread area TB.

During an adjustment of the step-plate element 1 by synchronously actuating the drive motors 31 and 32, an eccentric step corresponding to FIGS. 7A and 7C is reflected in a measurable and hence evaluable signal curve characteristic cs corresponding to FIG. 8 in motor current curves i1(t) and i2(t) for the two drive motors 31 and 32. In an eccentric load case, one of the drive motors 31, 32 is loaded more strongly on the step-plate element 1. The respective drive motor 31 or 32 thus experiences a greater load than the other drive motor 32, 31. This is also reflected in significantly changed curves for the different motor current signals i1(t) and i2(t) for the drive motors 31 and 32. This results in a change in one of the signal curves i1(t), i2(t) relative to the other signal curve, which goes beyond a tolerance value and which the electronic control unit 7 recognizes as the signal curve characteristic c₈ and triggers a particular control signal. A subsequently electronically controlled and automatically triggered reaction for example provides to differently actuate the drive motors 31 and 32 in the case of a detected eccentric load for the further adjusting movement, in order to (again) stabilize the adjusting movement of the step-plate element 1 and reach a (more) harmonic distribution of the load on the step-plate element 1.

Alternatively or additionally, a different limit value for a load-related stopping of the adjusting movement of the step-plate element 1 can be stored in the electronic control unit 7 depending on the detected load case corresponding to FIGS. 7A, 7B and 7C. In the case of an excessive load on the step-plate element 1 during the extension or retraction, an overload of the drive motors 31 and 32 is to be avoided, for example by stopping the drive motors 31 and 32 on occurrence of such a load case. In the case of a central load corresponding to FIG. 7B, both drive motors 31 and 32 jointly can tolerate an even greater load than in the case of an eccentric load corresponding to FIGS. 7A and 7C, in which especially one of the drive motors 31 and 32 is loaded more strongly and hence excessively at a faster rate.

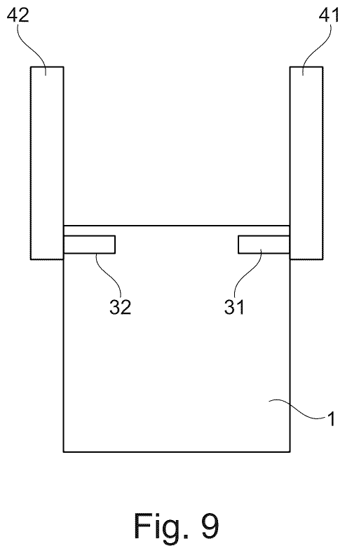

FIG. 9 illustrates the advantages of a redundant configuration of the drive system with two drive units 2A and 2B and hence two drive motors 31 and 32. The drive motors 31, 32 here are designed for an emergency operation in such a way that each drive motor 31, 32 at least once can apply a driving force in order to adjust the step-plate element 1, even if the respective other drive motor 32 or 31 has failed.

For example, when it is recognized at the electronic control unit 7 with reference to one or more evaluated sensor signals and/or an evaluated motor current signal or torque signal that one of the drive motors 31, 32 no longer works properly, the electronic control unit 7 can operate the other, still operable drive motor 31 or 32 in an emergency operating mode. It then for example is attempted to guide the possibly still extended step-plate element 1 back into a retracted rest position by means of the one still operable drive motor 31 or 32, so that the vehicle P with the retracted step-plate element 1 can be driven to a repair or autonomously drives to such repair. In the emergency operating mode, the step-plate element 1 can be adjusted via the one still operable drive motor 31 or 32 with an adjustment speed reduced as compared to a normal operating mode and possibly by specifically generating a jerking movement (due to the non-operable drive motor 32 or 31 on the other long side 12 or 11). Likewise, alternatively or additionally, in the emergency operating mode at least one one-time extension of the step-plate element 1 can be made possible with a fully retracted step-plate element 1 via the one still operable drive motor 31 or 32, e.g. in order to have passengers exit from the vehicle P.

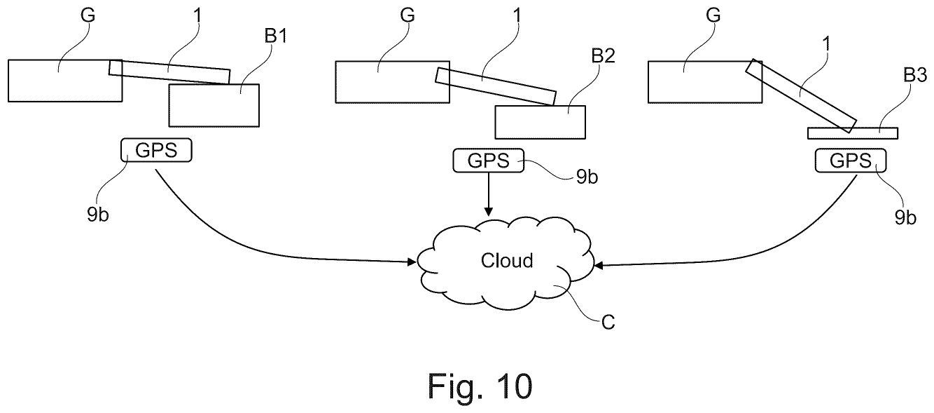

FIG. 10 schematically illustrates a control and monitoring of the drive system for the adjustment of the step-plate element 1 by utilizing at least one GPS sensor 9b. By means of the GPS sensor 9b, the electronic control unit 7 receives additional information on a geographical position of the vehicle P. In this way, measured values detected during an adjustment of the step-plate element 1, such as for example the motor current i(t), can be put into relation with a geographical position of the vehicle P. For example for a vehicle P of local public transport, the step-plate element 1 can be adjusted in different ways, depending on the stop at which the vehicle P stops. FIG. 10 in this connection illustrates different roadway borders in the form of curbstones B1, B2 and B3, which here by way of example differ from each other in terms of their height with respect to an entry edge, at which the step-plate element 1 can be extended. Thus, depending on the curbstone B1, B2, B3 an adjustment characteristic for the extending and retracting step-plate element 1 possibly differs. This is then also reflected in the detected measured values.

In addition, the utilization of at least one GPS sensor 9b also permits an improved location-specific control of the step-plate element 1. For example, depending on the geographical position different reference values can be stored for the detected measured values. In addition, the utilization of at least one GPS sensor 9b allows to more easily learn fixed routes or stops of the vehicle P in the electronic control unit 7, as data to be expected already are stored and thus for example an appropriate set of parameters can already be preselected in dependence on the respective stopping point on the route. In addition, it can also reliably be recognized with reference to a signal of the GPS sensor 9b when a stopping point deviating from a specified route is approached, for example due to a construction site. In a correspondingly detected operating situation, the drive motor 31, 32 can then be actuated for example by the electronic control unit with another (for example more robust) set of parameters. For an exact or more exact monitoring, it can also be checked with reference to GPS data at what stopping point the vehicle P is located. Then, a more exact matching with a location-specifically defined reference curve can then be provided for the detected measured values. For example, different location-specific reference curves can also initially be learned in a simple way by driving along the route with the vehicle P.

In addition, FIG. 10 illustrates that the drive system of the vehicle P also is adapted to wirelessly communicate with a superordinate monitoring system C, for example a cloud server system, in order to transmit data on the adjustment of the step-plate element 1. Via the monitoring system C it can thus be monitored at a distance from the autonomously driving vehicle P in how far the drive system and in particular its drive units 2A, 2B work properly. Via the monitoring system C a fleet management furthermore can also be implemented, via which several vehicles P are monitored in parallel.

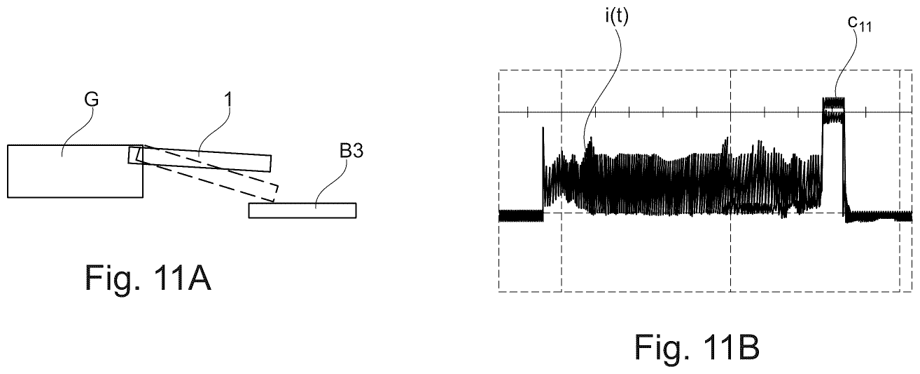

FIGS. 11A and 11B show a design variant in which the electronic control unit 7 controls an individual drive motor or several drive motors 31, 32 via a PWM signal. The electronic control unit 7 is configured to implement a speed-based damping on extension of the step-plate element 1, whereby the step-plate element 1 is adjusted with a reduced adjustment speed before reaching its final extension position (shown by way of example in FIG. 11A with broken lines). Then, a possible extension and/or lowering movement of the step-plate element 1 is carried out with a reduced adjustment speed in order to avoid an uncontrolled lowering or falling down of the step-plate element 1 onto a ground or here a curbstone B3.

With this objective, one drive motor 31, 32 or both drive motors 31, 32 can be actuated by the electronic control unit 7 via a reduced PWM signal before the final extension position is reached by the step-plate element 1, or it can be actively countersteered with the drive motors 31, 32. For example, it is provided to actuate the individual drive motor or the drive motors 31, 32 provided for the adjustment of the step-plate element 1 in the region of an adjustment range detected via a signal curve characteristic c₁₁ corresponding to FIG. 11B or already previously with a PWM signal which merely lies at 2% of a previously utilized PWM signal. For this design variant it is the objective that the electronic control unit 7 provides countersteering or a PWM reduction for the one or more drive motors 31, 32 with reference to a monitored parameter, such as the motor current, from a particular adjustment position of the step-plate element 1, in order to approach the step-plate element 1 to its final extension position with a lower adjustment speed.

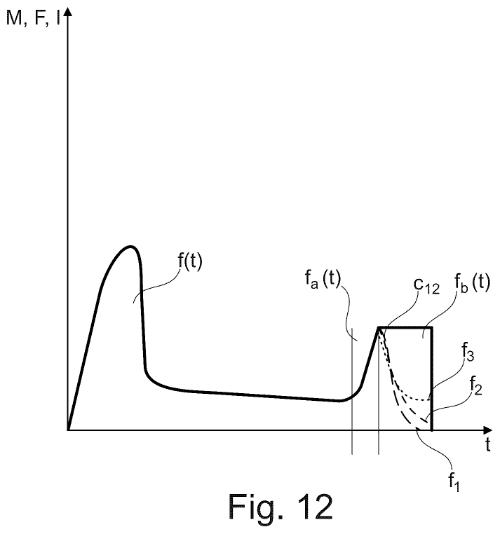

With reference to FIG. 12 a further design variant of a proposed drive system is illustrated. This variant, too, can be combined with all design variants explained above and below. FIG. 12 shows a diagram in which various possible detectable and evaluable measured values, such as for example a drive torque M, a driving force For a motor current I, are plotted over the time. FIG. 12 shows an exemplary measured value curve f(t). FIG. 12 furthermore illustrates an advantageous block sequence for the retraction of the step-plate element 1 into an end position, e.g. a retracted rest position within the base structure or the housing G. For example, there is detected a motor current (for example by a current measurement, current sensing or the like integrated into a bridge divider of the drive motor 31, 32) and matched with an information on the adjustment position of the step-plate element 1 or an expected traversing time (from an extended state to a retracted state, or vice versa). When this matching suggests that a rise of the motor current—in the diagram of FIG. 12 illustrated by a first functional portion fₐ(t)—is not caused due to a collision of the step-plate element 1 with an object, but by the retraction of the step-plate element or the drive mechanism into one or more end stops, the block sequence is carried out.

In connection with the design variant provided here, a block current will be present only for a short time in order to avoid an excessive load of the drive motor 31, 32. At the same time, however, it will be ensured that the step-plate element 1 moves into the respective corresponding end stop and also is held there. When in the present case a corresponding current rise correspondingly is detected on the part of the electronic control unit 7 with reference to a signal curve characteristic c₁₂ and hence—possibly in combination with the evaluation of additional information on an adjustment position of the step-plate element 1—a proper retraction of the step-plate element 1 into one or more end stops is inferred, an actuation voltage of the drive motor 31, 32 or of both drive motors 31, 32 is clocked down. Consequently, the motor current consequently decreases in a functional portion f_{b}(t). At the same time, the adjustment position of the step-plate element 1 is monitored, for example by drive-side Hall sensors 9c, in order to detect whether the step-plate element 1 possibly is pressed back from the end stops due to the reduced motor current. When a corresponding adjustment in the opposite direction is detected, the motor current and hence also the actuation voltage is increased again, in the present case up to a function value f₃. When subsequent to the lowering of the motor current no more change of the adjustment position is detected, it can be assumed that the step-plate element 1 is disposed in the intended end position and also remains there. Depending on the sensor signal of the drive-side sensor system, with which a possible return adjustment of the step-plate element 1 can be detected, an increase of the motor current can also be omitted so that the motor current is reduced to a function value f₁ equal to 0. Possibly, a smaller increase of the motor current to a function value f₂ can also be performed. An increase of the motor current and hence in particular of the generated driving force in connection with the proposed block sequence thus can possibly be varied in dependence on the detected return movement of the step-plate element 1.

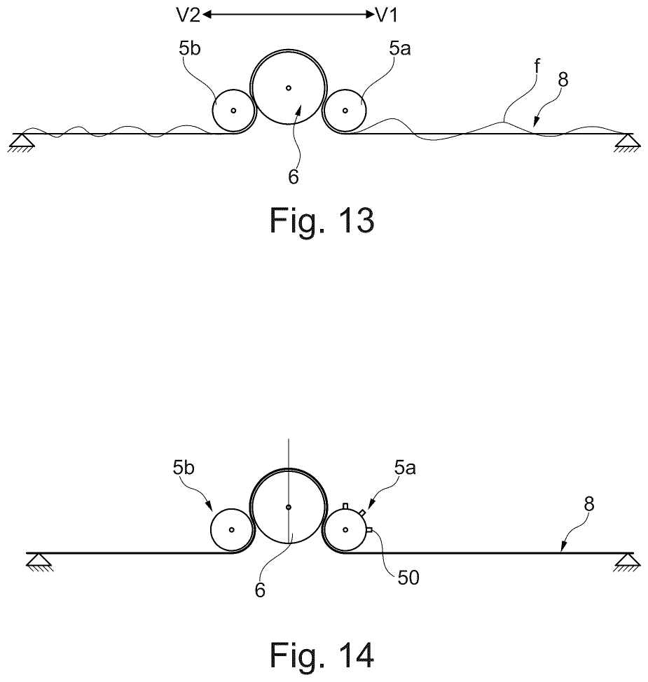

In connection with some of the design variants already explained above it has been set forth that an adjustment position of the step-plate element 1 can be determined both via a drive-side sensor system and with reference to a measured value for a drive-side parameter, such as for example the motor current or the drive torque. In a design variant illustrated with reference to FIGS. 13 and 14 it furthermore is possible to make use of the behavior of the toothed belt 8 during an adjustment of the step-plate element 1 and a feedback to the driving drive motor 31 or 32 by using a belt drive for the transmission of the driving force to the step-plate element 1.

By using the toothed belt 8 on the drive gear 6 and the guide rollers 5a, 5b the toothed belt 8 initially, at the beginning of an adjusting movement, runs up over an edge of the drive gear 6, and a tooth 80 of the toothed belt 8 is pulled up on the drive gear 6 when the tooth 80 moves into the drive gear 6. At this time, a comparatively small pressure still is applied to the respective tooth 80 of the toothed belt 8. When a tooth 80 of the toothed belt 8 then moves further into the drive gear 6, the pressure is increased and the tooth 80 is pressed into the mating contour of the drive gear 6. Hence, the toothed belt 8 consequently is slightly tensioned and relaxed repeatedly. This leads to measurable vibrations at the toothed belt 8. Such vibrations of the toothed belt 8 in turn are speed-dependent and can be detected in the motor current signal i(t), as the tensioning and relaxing of the toothed belt 8 requires differently large drive torques on the part of the drive motor 31 or 32 driving the drive gear 6. At low speeds, longer tensioning of the gearwheel element 8 is effected with a corresponding effect on the measured value curve. At higher speeds the motor current i(t) in turn cannot rise up to the current corresponding to the drive torque, as less time is available. With the omega-shaped course of the toothed-belt 8 around the guide rollers 5a, 5b and the drive gear 6 and the related twisting of the toothed belt 8, an operating state and functional state of the belt drive thus can be inferred with reference to a measured value detected for the drive motor 31, 32.

Furthermore, corresponding to FIG. 13 use can be made of the fact that depending on a position of a guide unit 21 or 22 adjusted along the toothed belt 8 the same has a different natural frequency f. A displacing movement of the gearwheel element 8 and in particular a vibration obtained during an adjustment of the step-plate element 1 thus varies when the step-plate element 1 is adjusted along its adjustment path in the different adjustment directions V1 and V2, with a corresponding influence on for example a detected motor current or a detected speed of the drive motor 31 or 32. A classification of the adjustment positions thereby can be effected via the frequency band so that for example an adjustment position close to an end stop and hence a rest position or extension position can be distinguished from an intermediate position. Corresponding influences by temperature, pretension and wear here can also be taken into account. Corresponding influencing factors are stored for example via one or more parameter values by learning. In a design variant corresponding to FIG. 13, a determination of an adjustment position of the step-plate element 1 thus is possible without any additional components and in particular without any additional sensor system, as solely by taking account of the configuration of the drive mechanism with the belt drive the adjustment position can be inferred via signal curve characteristics for measured values detected by a drive motor 31, 32.

This also is the case in a development according to FIG. 14. On at least one of the guide rollers 5a, 5b a signal characteristic generator in the form of a radially protruding tab 52 or a plurality of radially protruding tabs 42 additionally is provided. Via a tab 52 a displacing movement specifically is applied onto the portion of the toothed belt 8 guided on the guide unit 21, 22. Hence, a portion of the toothed belt 8 is mechanically acted upon in a targeted way in various rotary positions of the respective guide roller-in FIG. 14 the guide roller 5a. Thereby, for example a kind of mechanical ripple is generated and hence a targeted change in a vibration occurring on the toothed belt 8 during an adjusting movement of the step-plate element 1, which in turn has an influence on the motor current curve or speed curve. For example by counting the occurred deviations in the vibrations of the toothed belt 8, which are caused in a targeted way by the tabs 52, an adjustment position of the step-plate element 1 can be inferred more easily and possibly also more exactly.

The development of FIG. 14 also allows an easier detection of possible ageing effects. For example, when the changes observed in the respective monitored measured value are less pronounced, this suggests a smaller displacing movement on the toothed belt 8. This in turn can suggest an ageing-related wear within the belt drive.

The design variants explained above can also be combined with each other, as already repeatedly emphasized above. With each of the design variants not only an improved control of a step-plate element 1 to be adjusted in a power-operated way is possible on a vehicle P. Rather, there is also provided in improved possibility of effectively monitoring the operability of the drive system especially in autonomously driving vehicles on the basis of data detected and evaluated on the part of the drive, and to newly train and/or improve algorithms utilized for the control, by means of which the signal curve characteristics cᵢ to c₁₂ are recognized and which trigger particular reactions on the part of the electronic control unit 7.

### LIST OF REFERENCE NUMERALS

1 step-plate element
11,12 longitudinal side
21, 22 guide unit
2A, 2B drive unit
31,32 drive motor
301, 302 signal line
41,42 guide profile
50 connecting flange
51 step-plate receptacle
52 tab
5a, 5b guide roller
6 toothed belt gear/drive gear
7 electronic control unit
8 toothed belt
80 tooth
9a, 9b, 9c sensor
A adjustment axis
B1, B2, B3 curbstone
c₁-c₁₂ signal curve characteristic
C monitoring system
F foot
f(f) measured value curve
G base structure/housing
i(t) motor current curve
m(t) torque curve
P vehicle
S snow pile
s_{g} sensor signal
T1, T2 door
TB tread area
V1, V2 adjustment direction

1. A drive system comprising an adjustable step-plate element for facilitating at least one of entry and boarding at an access opening of a vehicle, wherein the drive system comprises at least one drive unit with at least one drive motor for generating a driving force for adjustment of the step-plate element and a drive mechanism for a transmission of the driving force to the step-plate element,
wherein the drive system comprises an electronic control unit, which is configured to evaluate at least one measured value which is characteristic for operation of the drive unit, from at least one of the drive motor and a sensor of the drive system associated with the drive unit for at least one of controlling and monitoring the at least one drive unit.

2. The drive system according to claim 1, wherein the electronic control unit is configured to evaluate at least one curve of the at least one measured value for at least one of controlling and monitoring the at least one drive unit.

3. The drive system according to claim 1, wherein at least one of:
the evaluated measured value of the drive motor is a motor current or a drive torque and
the evaluated measured value of the sensor associated with the drive unit is a measured value of a position or speed sensor or a sensor configured to monitor surroundings of the step-plate element, the sensor configured to monitor surroundings of the step-plate element comprising a capacitive sensor, an optical sensor, a radar sensor, or an ultrasonic sensor.

4. (canceled)

5. The drive system according to claim 1, wherein the electronic control unit is configured, for at least one of controlling and monitoring the at least one drive unit, to evaluate at least one curve of the at least one measured value for occurrence of at least one signal curve characteristic, which is representative of a particular operating state, a particular functional state, or a particular adjustment position of the step-plate element.

6. The drive system according to claim 5, wherein for a detection of the particular operating state or the particular functional state, the electronic control unit additionally takes account of a geographical position of the drive system.

7. The drive system according to claim 6, wherein the electronic control unit is configured to receive information on the particular adjustment position of the step-plate element
a) from a second sensor coupled with the drive system or from the sensor, of the drive system associated with the drive unit, or
b) to determine said information from the at least one curve of the at least one measured value.

8. The drive system according to claim 5, wherein the electronic control unit is configured to detect, with reference to the at least one signal curve characteristic,
an additional load on the step-plate element during the adjustment, or
a collision of the step-plate element during adjustment of the step-plate element into an extension position, or
an extension of the step-plate element to or into a compliant surrounding material, or
a sluggishness in the drive mechanism, or
a malfunction of the drive unit.

9. The drive system according to claim 5, wherein at least one of:
the electronic control unit is configured to detect the occurrence of the signal curve characteristic on the basis of at least one stored reference value or a stored reference value curve, and
the electronic control unit is configured to distinguish various signal curve characteristics from each other and in response thereto to generate different reaction signals.

10. (canceled)

11. The drive system according to claim 8 wherein the electronic control unit is configured to distinguish various signal curve characteristics from each other and in response thereto to generate different reaction signals and to detect the additional load on the step-plate element during the adjustment with reference to the at least one signal curve characteristic and in dependence on the at least one signal curve characteristic to detect at least one of what kind of load acts on the step-plate element and at what point the load acts on the step-plate element.

12. The drive system according to claim 5, wherein the electronic control unit is configured to distinguish various signal curve characteristics from each other and in response thereto to generate different reaction signals, wherein at least one of
the electronic control unit additionally takes account of an information on an adjustment position of the step-plate element for detecting at least one of what kind of load acts on the step-plate element and at what point the load acts on the step-plate element, and
the electronic control unit is configured to recognize at least one of how fast and how long the load acts on the step-plate element, and in this way distinguish at least two load cases from each other, which lead to different control signals generated by the electronic control unit for controlling the drive motor based on the at least two load cases.

13. (canceled)

14. The drive system according to claim 1, wherein the drive mechanism comprises a belt drive for the transmission of the driving force to the step-plate element.

15. The drive system according to claim 14, wherein at least one of:
the belt drive comprises a toothed belt, and
the toothed belt meshes with a drive gear which can be driven by the drive motor to perform a rotation.

16. (canceled)

17. (canceled)

18. (canceled)

19. The drive system according to claim 8, wherein the drive mechanism comprises a belt drive for the transmission of the driving force to the step-plate element, and wherein the electronic control unit is configured to evaluate at least one signal curve characteristic caused by the belt drive in a curve of the measured value detected for the drive motor.

20. The drive system according to claim 19, wherein the signal curve characteristic originates from a displacing movement.

21. The drive system according to claim 20, wherein at least one of:
the signal curve characteristic originates from a natural frequency of a belt of the belt drive, the natural frequency being variable along at least one of: the adjustment path of the step-plate element, and different operating and functional states of the drive unit, and
the signal curve characteristic originates from at least one displacing movement of the belt, which is generated via at least one signal characteristic generator at the belt drive on at least one adjustment position of the step-plate element.

22. (canceled)

23. The drive system according to claim 1, wherein at least one of:
the electronic control unit is configured to actuate or actively countersteer the drive motor via a reduced PWM signal before an extension position is reached by the step-plate element, and
the electronic control unit is configured to actuate the drive motor to move the step-plate element into an end position, in which the step-plate element is retracted into one or more end stops, via a block sequence, in which the electronic control unit reduces the driving force applied by the drive motor and, after the electronic control unit reduces the driving force applied by the drive motor, the electronic control unit monitors the drive mechanism to detect whether a displacement of the step-plate element is effected in an opposite direction, and, responsive to detecting the displacement, the drive motor is actuated for generating a larger driving force.

24. (canceled)

25. The drive system according to claim 1, wherein the drive system comprises two drive units with one drive motor each and the drive mechanism for adjusting the step-plate element.

26. The drive system according to claim 5, wherein the electronic control unit is configured to distinguish various signal curve characteristics from each other and in response thereto to generate different reaction signals, wherein the drive system comprises two drive units with one drive motor each and the drive mechanism for adjusting the step-plate element, wherein for an adjustment of the step-plate element, the drive motors of both drive units each generate a driving force, and the electronic control unit is configured to evaluate a curve of motor current or of a drive torque for each drive motor for controlling the drive units.

27. (canceled)

28. (canceled)

29. (canceled)

30. A vehicle for local public transport, comprising at least one access opening, via which persons can at least one of enter into the vehicle and exit from the vehicle, and the drive system according to claim 1.

31. A method for operating a drive system comprising an adjustable step-plate element for facilitating at least one of entry and boarding at an access opening of a vehicle, wherein the drive system comprises at least one drive unit with at least one drive motor for generating a driving force for adjustment of the step-plate element and a drive mechanism for a transmission of the driving force to the step-plate element,
the method comprising evaluating at least one measured value, which is characteristic of operation of the drive unit, from at least one of the drive motor and a sensor of the drive system for at least one of controlling and monitoring the at least one drive unit, the sensor associated with the drive unit.
